(19) United States
(12) Patent Application Publication
(10) Pub. No.: US 2012/0171037 A1
(43) Pub. Date: Jul. 5, 2012

(54) PROBE ASSEMBLY FOR USE IN TURBINE ENGINES AND METHOD OF ASSEMBLING SAME

(76) Inventors: Prathap Raj R, Banglaore (IN); Kurt Kramer Schleif, Greenville, SC (US); Fernando Jorge Casanova, Greenville, SC (US)

(21) Appl. No.: 12/983,369

(22) Filed: Jan. 3, 2011

(51) Int. Cl. F01D 5/02; G01M 15/14; B23P 11/00

(52) U.S. Cl. 416/61; 29/428; 29/464; 73/112.01

(57) ABSTRACT

A method of assembling a probe assembly is provided. At least one probe is coupled to an annular tube, wherein the tube includes an interior surface and an exterior surface. The tube also includes at least one first opening that extends between the interior and exterior surfaces and at least one second opening that extends between the interior and exterior surfaces. Moreover, at least one annular flange is coupled to the tube. The flange has a substantially elliptical shape that facilitates substantially preventing the relative rotation of the tube.

### BACKGROUND OF THE INVENTION

The field of the present invention relates generally to turbine engines and, more particularly, to a probe assembly that can be used in a rotor of a turbine.

At least some known power generation systems include at least one component that may become damaged or worn over time. For example, known turbines include components such as, rotors that wear over time. Continued operation with a worn rotor may cause additional damage to other components or may lead to critical cracking of the rotor and/or a premature failure of the component or system. As such, routine assessments and/or tests of components of a turbine engine are necessary.

Proper instrumentation is essential to perform such tests. For example, in examining a rotor and/or its surrounding flow parameters, sensing instruments, such as a probe, may be used to measure various conditions of the rotor and/or turbine. Moreover, at least some known probes may be inserted into a rotor bore of the turbine engine to provide real time data on various features and/or parameters of the rotor.

Known probes may be contained in a housing or assembly, such as a plug or bore tube, that helps properly align and position the probe within a rotor bore. More specifically, such plugs carry the probes and such bore tubes generally carry the instrumentation leads. Moreover, such plugs or bore tubes are aligned within the axial center of the rotor bore. At least some known plugs or bore tubes are cylindrical and are coupled to the rotor using pins that are inserted into slots spaced circumferentially about the rotor bore. However, forming such slots near the rotor bore may create a substantial amount of stress concentration on the rotor during operation. Over time, continued operation with such stresses may lead to cracking of the rotor and/or premature failure of the component or system.

### BRIEF DESCRIPTION OF THE INVENTION

In one embodiment, a method of assembling a probe assembly is provided. At least one probe is coupled to an annular tube, wherein the tube includes an interior surface and an exterior surface. The tube also includes at least one first opening that extends between the interior and exterior surfaces and at least one second opening that extends between the interior and exterior surfaces. Moreover, at least one annular flange is coupled to the tube. The flange has a substantially elliptical shape that facilitates substantially preventing the relative rotation of the tube.

In another embodiment, a probe assembly is provided. The probe assembly includes at least one probe and an annular tube coupled to the probe, wherein the tube includes an interior surface and an exterior surface. The tube includes at least one first opening and at least one second opening, wherein each of the first and the second openings extends between the interior and exterior surfaces. Moreover, the probe assembly includes at least one annular flange that extends from the tube, wherein the flange has a substantially elliptical shape. The flange facilitates substantially preventing the relative rotation of the tube.

In another embodiment, a turbine engine is provided. The turbine engine provides a compressor, a turbine coupled in flow communication with the compressor, a rotor shaft rotatably coupled to the turbine, wherein the rotor shaft includes a bore that extends axially at least partially therethrough. Moreover, the turbine engine includes a probe assembly that is coupled to the rotor shaft. The probe assembly includes at least one probe and an annular tube coupled to the probe, wherein the tube includes an interior surface and an exterior surface. The tube includes at least one first opening and at least one second opening, wherein each of the first and the second openings extends between the interior and exterior surfaces. Moreover, the probe assembly includes at least one annular flange that extends from the tube, wherein the flange has a substantially elliptical shape. The flange facilitates substantially preventing the relative rotation of the tube during operation of the turbine engine.

### BRIEF DESCRIPTION OF THE DRAWINGS

FIG. 1 is a cross-sectional schematic view of an exemplary turbine engine;

FIG. 2 is a cross-sectional schematic view of a portion of an exemplary rotor assembly that may be used with the turbine engine shown in FIG. 1 and taken along area 2;

FIG. 3 is a perspective schematic view of an exemplary probe assembly that may be used with the rotor assembly shown in FIG. 1 and taken along area 3;

FIG. 4 is an enlarged cross-sectional schematic view of a portion of the probe assembly shown in FIG. 3 and taken along line 4-4; and

FIG. 5 is an exemplary method of assembling the probe assembly shown in FIG. 3.

### DETAILED DESCRIPTION OF THE INVENTION

The exemplary method and systems described herein overcome disadvantages of at least some known probe assemblies and housings that include at least some plugs or bore tubes, for example, that are used with a rotor of a turbine engine. More specifically, the embodiments described herein provide a probe assembly that includes a tube that is coupled to at least one flange that has a substantially elliptical shape. The shape of the flange facilitates concentrically aligning the tube within a bore defined in a rotating element to substantially prevent the relative rotation of the tube during operation of the turbine engine. Moreover, having an assembly with such a flange enables the rotor bore to be formed without the inclusion of inspection slots and the assembly enables the plug and/or bore tube to be used without inclusion of any pins and/or slots, such that an amount of stress concentration induced to the rotor is reduced as compared to at least some known rotors that include plugs or bore tubes.

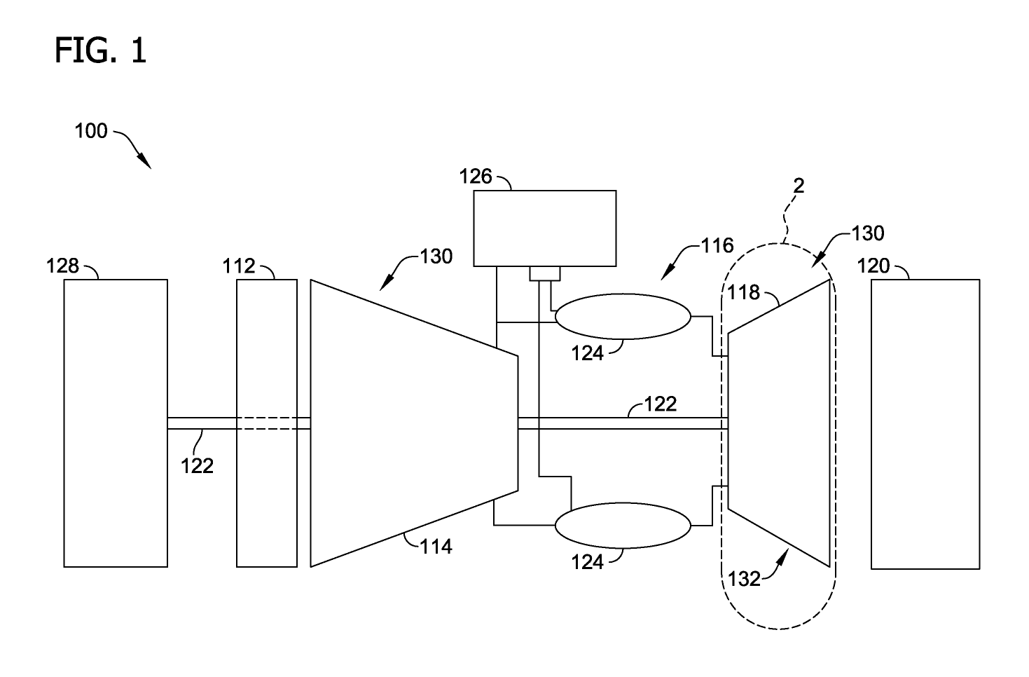

FIG. 1 is a schematic cross-sectional view of an exemplary turbine engine 100. More specifically, in the exemplary embodiment, turbine engine 100 is a gas turbine engine. While the exemplary embodiment is described with respect to a gas turbine engine, the present invention is not limited to any one particular engine, and one of ordinary skill in the art will appreciate that the current invention may be used in connection with other turbine engines. For example, the present invention may be used in pumps and other rotating machines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is positioned in flow communication with the compressor section 114. A fuel nozzle assembly 126 is coupled to each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and ignited to generate combustion gases that are channeled towards turbine section 118. More specifically, in combustors 124, fuel, for example, natural gas and/or fuel oil, is injected into the air flow, and the fuel-air mixture is ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132.

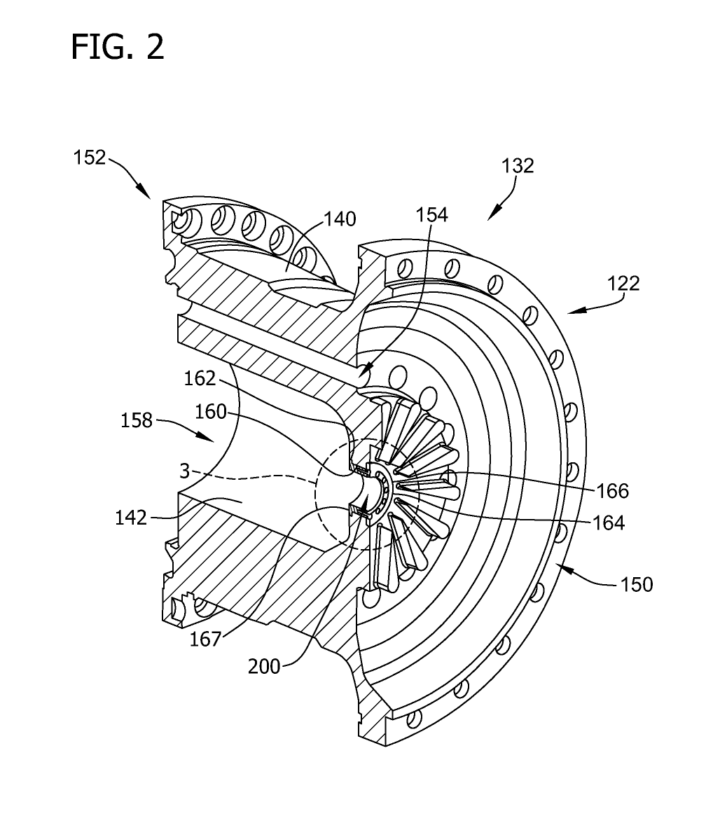

FIG. 2 is a schematic cross-sectional view of a portion of rotor assembly 132 that may be used with turbine engine 100 and taken along area 2 (shown in FIG. 1). More specifically, in the exemplary embodiment, rotor shaft 122 is substantially cylindrical and includes an exterior surface 140 and an interior surface 142. Rotor shaft 122 also includes an aft end 150 and a forward end 152. Moreover, rotor shaft 122 includes a plurality of cooling air ducts 154 that extend substantially axially at least partially through shaft 122. Moreover, a cavity 158 is defined within shaft interior surface 142. Ducts 154 substantially circumscribe cavity 158 and a central cooling air supply (not shown) is coupled to shaft 122 to channel an air flow in a generally axial direction through cavity 158.

In the exemplary embodiment, a bore 160 extends substantially axially through at least a portion of rotor shaft 122. More specifically, in the exemplary embodiment, bore 160 extends from aft end 150 to cavity 158, wherein bore 160 and cavity 158 are substantially concentrically aligned with each other. Moreover, in the exemplary embodiment, bore 160 includes an end piece 162 that extends circumferentially about bore 160 and defines an inner surface 164 of bore 160. Furthermore, bore 160 includes an inner perimeter surface 166 and an outer perimeter surface 167. Moreover, in the exemplary embodiment, a probe assembly 200 is substantially concentrically aligned within bore 160, such that assembly 200 is aligned against bore inner surface 164.

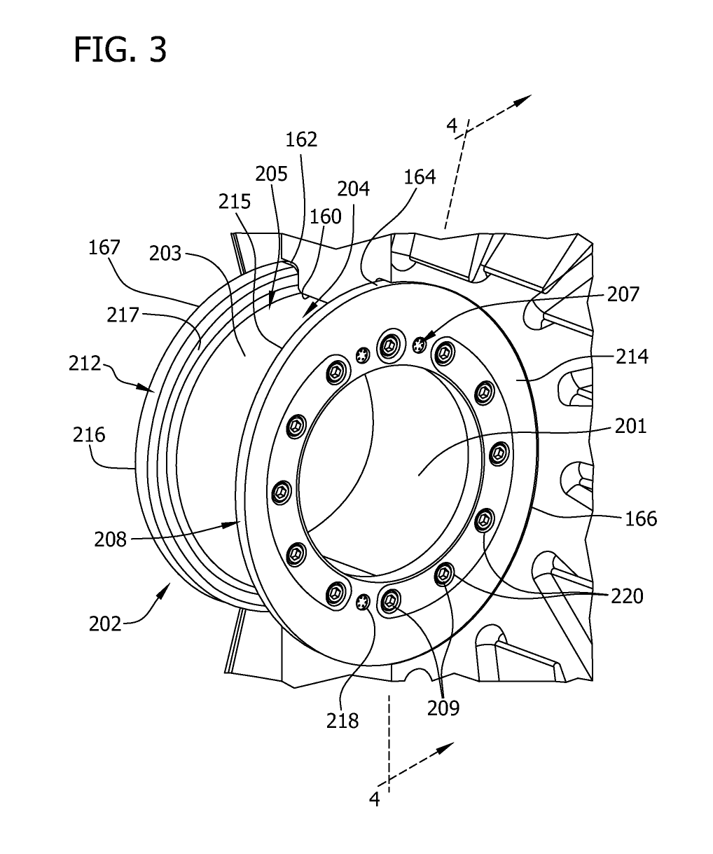

FIG. 3 is a perspective schematic view of probe assembly 200 taken along area 3 (shown in FIG. 2). In the exemplary embodiment, assembly 200 includes an annular tube 202 that has an aft end 204 and a forward end 205. Alternatively, tube 202 may not be annular and may not have an interior opening within its center, so long as tube 202 enables assembly 200 to function as described herein. Moreover, in the exemplary embodiment, tube 202 includes an interior surface 201 and an exterior surface 203. In the exemplary embodiment, tube 202 is substantially cylindrical. Alternatively, tube 202 may be any shape that enables tube 202 to fit within bore 160 and to function as described herein.

Tube 202 includes at least one first opening (not shown in FIG. 2) that extends substantially axially between interior surface 201 and exterior surface 203. Moreover, in the exemplary embodiment, tube 202 also includes at least one second opening (not shown in FIG. 2) that extends substantially axially at least partially between interior surface 201 and exterior surface 203. Moreover, assembly 200 includes at least one probe 207 that is at least partially inserted within the tube first opening.

Moreover, in the exemplary embodiment, assembly 200 includes at least one annular flange 208 that is substantially elliptical and that is coupled to tube 202. More specifically, in the exemplary embodiment, flange 208 is coupled to tube 202 via at least one bolt 209. In the exemplary embodiment, flange 208 is a first annular flange 208 and assembly 200 also includes a second annular flange 212. In the exemplary embodiment, first flange 208 has a first surface 214 and a second surface 215. Similarly, second flange 212 has a first surface 216 and a second surface 217.

First flange 208 has at least one first opening 218 that extends at least partially through flange 208 and at least one second opening 220 that extends at least partially through flange 208. More specifically, in the exemplary embodiment, flange first opening 218 extends from first surface 214 through second surface 215. In the exemplary embodiment, flange 208 is formed with three flange first openings 218 and each flange first opening 218 contains one probe 207.

Moreover, in the exemplary embodiment, flange second opening 220 extends from first surface 214 through second surface 215. In the exemplary embodiment, first flange 208 has twelve second openings 220 and each flange second opening 220 contains one bolt 209.

First flange 208 is coupled to tube aft end 204 via bolt 209. In the exemplary embodiment, twelve bolts 209 are used to couple first flange 208 to tube 202. Alternatively, any number of bolts 209 may be used to couple first flange 208 to tube 202.

In the exemplary embodiment, second flange 212 is formed integrally with tube forward end 205, and extends outwardly from tube 202. More specifically, second surface 217 of second flange 212 is formed integrally with tube 202. Alternatively, first flange 208 and/or second flange 212 may be coupled to, and/or formed integrally with, tube 202.

Moreover, in the exemplary embodiment, first flange 208 is annular and has a substantially elliptical shape. Alternatively, first flange 208 may have any substantially non-circular shape that enables assembly 200 to function as described herein. In the exemplary embodiment, second flange 212 is annular and has a substantially circular shape. Alternatively, second flange 212 may have an elliptical shape or any non-circular shape, as long as at least one of flange 208 and flange 212 has a shape that enables assembly 200 to function as described herein.

In the exemplary embodiment, tube 202 is positioned against bore inner surface 164. Moreover, in the exemplary embodiment, flange 208 is coupled to end piece 162 and is positioned against bore outer perimeter surface 167 such that tube 202 is securely coupled within bore 160.

During operation, intake section 112 channels air towards compressor section 114 wherein the air is compressed to a higher pressure and temperature prior to being discharged towards combustor section 116. The compressed air is mixed with fuel and ignited to generate combustion gases that are channeled towards turbine section 118. More specifically, in combustors 124, fuel, for example, natural gas and/or fuel oil, is injected into the air flow, and the fuel-air mixture is ignited to generate high temperature combustion gases that are channeled towards turbine section 118.

Turbine section 118 converts thermal energy from the gas stream to mechanical rotational energy. More specifically, the combustion gases impart rotational energy to turbine section 118 and to rotor assembly 132 enabling rotor assembly 132 to rotate. The elliptical shape of first flange 208 enables tube 202 to be concentrically aligned within bore 160. Such an alignment enables tube 202 to be securely coupled within bore 160 in order to substantially prevent the relative rotation of tube 202 during operation of turbine engine 100. This reduction in the relative rotation of tube 202 enables probe 207 to accurately measure various components and features of rotor assembly 132. Moreover, the use of flange 208 prevents the formation and use of slots near rotor bore 160, thus resulting in substantially reducing the amount of stress on rotor assembly 132.

Moreover, the elliptical shape of flange 208 enables positioning probe 207 at a circumferentially desired location. Moreover, probe assembly 200 may also be used in coupling any two rotating parts (not shown) where the torque transmission is substantially reduced.

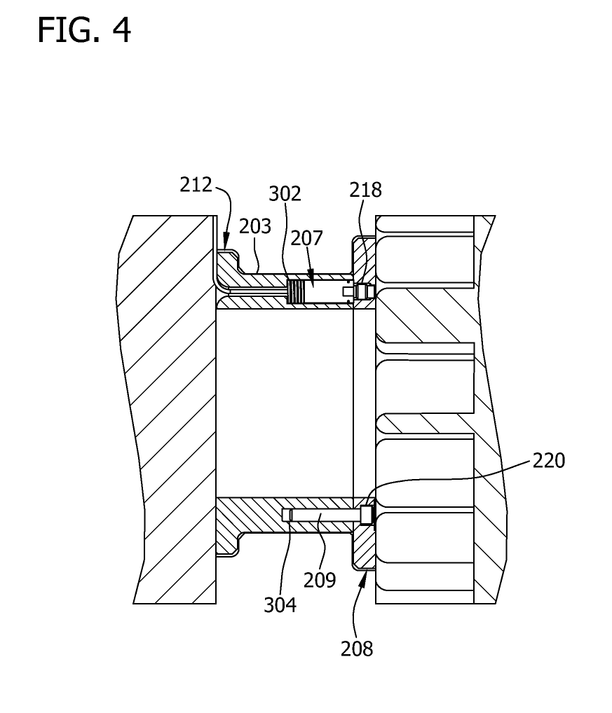

FIG. 4 is an enlarged cross-sectional schematic view of a portion of probe assembly 200 taken along line 4-4 (shown in FIG. 3). In the exemplary embodiment, tube 202 includes at least one first opening 302 that extends substantially axially at least partially between tube interior and exterior surfaces 201 and 203, respectively. Moreover, tube includes 202 includes at least one second opening 304 that extends substantially axially at least partially between tube interior and exterior surfaces 201 and 203, respectively.

In the exemplary embodiment, each flange first opening 218 is aligned substantially concentrically with each tube first opening 302. Moreover, one probe 207 is at least partially inserted within each tube first opening 302. Each probe 207 extends from tube first opening 302 into flange first opening 218. Each tube second opening 304 is aligned substantially concentrically with each flange second opening 220. Each second tube opening 304 contains one bolt 209. Each bolt 209 extends from tube second opening 304 into flange second opening 220.

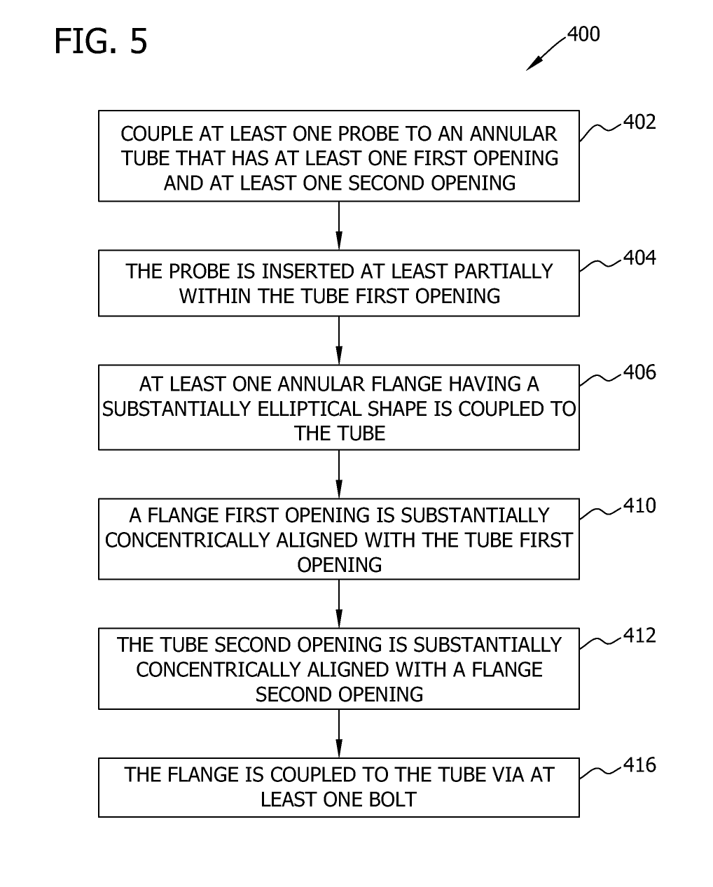

FIG. 5 illustrates an exemplary method 400 of assembling a probe assembly for use in turbine engine 100 (shown in FIG. 1), such as probe assembly 200 (shown in FIGS. 2, 3 and 4). In the exemplary embodiment, at least one probe (shown in FIGS. 3 and 4) is coupled 402 to an annular tube 202 (shown in FIGS. 3 and 4) that has at least one first opening 302 (shown in FIG. 4) that extends substantially axially at least partially between an interior surface 201 (shown in FIGS. 3 and 4) and an exterior surface 203 (shown in FIGS. 3 and 4) of tube 202. Probe 207 (shown in FIGS. 3 and 4) is inserted 404 at least partially within the tube first opening 302. At least one annular flange 208 (shown in FIGS. 3 and 4) having a substantially elliptical shape is coupled 406 to tube 202. The shape of flange 208 facilitates substantially concentrically aligning tube 202 within a bore 160 (shown in FIGS. 2 and 3) that extends substantially axially at least partially through a rotor shaft 122 (shown in FIGS. 1, 2 and 3), to substantially prevent the relative rotation of tube 202 during operation of turbine engine 100.

Moreover, in the exemplary embodiment, a flange first opening 218 (shown in FIGS. 3 and 4) is aligned 410 substantially concentrically with tube first opening 302. The tube second opening 304 is aligned 412 substantially concentrically with a flange second opening 220 (shown in FIGS. 3 and 4). Probe 207 extends from tube first opening 302 into the flange first opening 218. Moreover, flange 208 is coupled 416 to tube 202 via at least one bolt 209 (shown in FIGS. 2 and 3).

The above-described probe assembly enables monitoring and testing a rotor of a turbine in a manner that substantially reduces the amount of stress on the rotor. More specifically, the probe assembly includes a tube that contains a probe and the tube is coupled to at least one flange that has a substantially elliptical shape. The substantially elliptical shape of the flange is different from the circular shape of at least some known plugs and bores. Moreover, the substantially elliptical shape of the flange enables the tube to be substantially concentrically aligned within a bore of a rotating element such that the relative rotation of the tube is substantially eliminated during operation of the turbine engine. Moreover, having an assembly with such a flange avoids the formation and use of slots near the rotor bore, resulting in a substantial reduction in the amount of stress on the rotor when compared to at least some known plugs and bore tubes.

Exemplary embodiments of a probe assembly and method of assembling same are described above in detail. The probe assembly and method of assembling same are not limited to the specific embodiments described herein, but rather, components of the probe assembly and/or steps of the probe assembly may be utilized independently and separately from other components and/or steps described herein. For example, the probe assembly may also be used in combination with other machines and methods, and is not limited to practice with only the power system as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of assembling a probe assembly, said method comprising:
coupling at least one probe to an annular tube, wherein the tube includes an interior surface and an exterior surface, the tube includes at least one first opening extending between the interior and the exterior surfaces and at least one second opening that extends between the interior and the exterior surfaces; and
coupling at least one annular flange to the tube, wherein the at least one annular flange has a substantially elliptical shape that facilitates substantially preventing the relative rotation of the tube.

2. A method in accordance with claim 1, wherein coupling at least one probe to an annular tube further comprises inserting the at least one probe at least partially within the at least one first opening.

3. A method in accordance with claim 1, wherein coupling at least one annular flange to the tube further comprises coupling at least one annular flange including at least one first opening extending at least partially therethrough and at least one second opening extending at least partially therethrough to the tube.

4. A method in accordance with claim 3 further comprising:
aligning the at least one flange first opening substantially concentrically with the at least one tube first opening; and
aligning the at least one tube second opening substantially concentrically with the at least one flange second opening, wherein the probe extends from the at least one tube first opening and into the at least one flange first opening.

5. A method in accordance with claim 4 further comprising coupling the at least one flange to the tube via at least one bolt.

6. A method in accordance with claim 1, wherein coupling at least one annular flange to the tube further comprises coupling a first annular flange and a second annular flange to the tube, wherein at least one of the first flange and the second flange has a substantially elliptical shape.

7. A method in accordance with claim 1, wherein coupling at least one annular flange to the tube further comprises coupling at least one annular flange that has a substantially elliptical shape that facilitates substantially aligning the tube within a bore extending axially at least partially through a rotating element.

8. A probe assembly, said probe assembly comprising:
at least one probe;
an annular tube coupled to said at least one probe, wherein said tube comprises an interior surface and an exterior surface, said tube further comprises at least one first opening and at least one second opening, each of said first and second openings extends between said interior and exterior surfaces; and
at least one annular flange comprising a substantially elliptical shape extending from said tube, said at least one flange facilitates substantially preventing the relative rotation of said tube.

9. A probe assembly in accordance with claim 8, wherein said at least one flange facilitates substantially aligning said tube within a bore extending axially at least partially through a rotating element.

10. A probe assembly in accordance with claim 8, wherein said at least one probe is at least partially inserted within said at least one first opening.

11. A probe assembly in accordance with claim 10, wherein said at least one flange comprises at least one first opening extending at least partially therethrough and at least one second opening extending at least partially therethrough, said at least one flange first opening is substantially concentrically aligned with said at least one tube first opening, said probe extends from said at least one tube first opening and into said at least one flange first opening.

12. A probe assembly in accordance with claim 11, wherein said at least one tube second opening is aligned substantially concentrically with said at least one flange second opening.

13. A probe assembly in accordance with claim 8, wherein said at least one flange is coupled to said tube via at least one bolt.

14. A probe assembly in accordance with claim 8, wherein said at least one annular flange comprises a first flange and a second flange, at least one of said first flange and said second flange comprises an elliptical shape.

15. A turbine engine comprising:
a compressor;
a turbine coupled in flow communication with said compressor;
a rotor shaft rotatably coupled to said turbine, wherein said rotor shaft comprises a bore extending substantially axially at least partially therethrough;
a probe assembly coupled to said rotor shaft, wherein said probe assembly comprises:
at least one probe;
an annular tube coupled to said at least one probe, wherein said tube comprises an interior surface and an exterior surface, said tube further comprises at least one first opening and at least one second opening, each of said first and second openings extends between said interior and exterior surfaces; and
at least one annular flange comprising a substantially elliptical shape extending from said tube, said at least one flange facilitates substantially preventing the relative rotation of said tube during operation of said turbine engine.

16. A turbine engine in accordance with claim 15, wherein said at least one flange facilitates substantially aligning said tube within said bore.

17. A turbine engine in accordance with claim 15, wherein said at least one probe is at least partially inserted within said at least one first opening.

18. A turbine engine in accordance with claim 17, wherein said at least one flange comprises at least one first opening extending at least partially therethrough and at least one second opening extending at least partially therethrough, said at least one flange first opening is aligned substantially concentrically with said at least one tube first opening, said at least one probe extends from said at least one tube first opening and into said at least one flange first opening.

19. A turbine engine in accordance with claim 15, wherein said at least one flange is coupled to said tube via at least one bolt.

20. A turbine engine in accordance with claim 15, wherein said at least one flange comprises a first flange and a second flange, at least one of said first flange and said second flange comprises a substantially elliptical shape.
